(19) United States
(12) Patent Application Publication
(10) Pub. No.: US 2025/0124834 A1
(43) Pub. Date: Apr. 17, 2025

(54) END-TO-END TELLTALE VERIFICATION FOR AUTOMOTIVE SYSTEMS AND APPLICATIONS

(71) Applicant: NVIDIA Corporation, Santa Clara, CA (US)

(72) Inventors: Rudolf H. J. BLOKS, Campbell, CA (US); Arun Kumar SWAIN, Morgan Hill, CA (US)

(21) Appl. No.: 18/678,717

(22) Filed: May 30, 2024

Related U.S. Application Data
(60) Provisional application No. 63/544,094, filed on Oct. 13, 2023.

(51) Int. Cl. G09G 3/00; B60Q 9/00; G06F 9/455; G09G 5/00; G09G 5/14

(52) U.S. Cl. CPC G09G 3/006; G06F 9/4555; G09G 5/006; G09G 5/14; B60Q 9/00; G06F 2009/45583; G06F 2009/45591; G09G 2330/12; G09G 2360/18; G09G 2370/20

(57) ABSTRACT

In various examples, a technique for end-to-end telltale verification for automotive systems and applications includes receiving, from a buffer, a set of commands associated with a frame to be displayed on a screen. The technique also includes determining, based at least on the set of commands, (i) an expected checksum for a telltale to be included in the frame and (ii) at least a portion of the frame associated with the telltale. The technique further includes computing a checksum for the at least the portion of the frame, and causing an alert associated with the telltale to be generated based at least on a comparison of the computed checksum with the expected checksum.

### CROSS-REFERENCE TO RELATED APPLICATIONS

This application claims the priority benefit of U.S. Provisional Application No. 63/544,094, filed on Oct. 13, 2023, which is hereby incorporated by reference in its entirety.

### BACKGROUND

In automotive, machine, and/or other systems, a telltale (alternatively referred to as a warning light, a dummy light, an indicator light, a malfunction light, an engine light, a dash light, etc.) includes an image and/or another visual representation that alerts an operator of a vehicle or machine to an important safety-related event or condition. For example, a telltale may be displayed as an indication of a potential hazard related to a nearby object, weather, road conditions, traffic conditions, malfunctions, failures, and/or other types of situations. In response to such a potential hazard, a virtual machine running within a display pipeline may program a display controller to display a corresponding telltale within a frame on a screen. The display controller typically preprocesses and composes multiple input channels (“windows”) into a single image, which is then further post-processed to create a final frame to be shown on the screen. A given telltale is generally included in a corresponding window for blending on top of other windows to ensure visibility. A guest virtual machine is used to control this window channel and the associated settings.

However, errors made by software and/or hardware may prevent a telltale from being displayed as intended, which can lead to safety issues. For example, an inability to display a telltale and/or an incorrect display of the telltale may prevent the operator of a machine or vehicle from becoming aware of a corresponding safety-related event or condition.

To mitigate potential errors in displaying telltales, a checksum (e.g., a Cyclic Redundancy Check (CRC)) may be computed over the pixels in a region where the telltale is to be shown. The computed checksum may be compared with an expected checksum for the region. Any mismatch in the two checksums may then be used to generate an alert, safety error, and/or another indication of an issue associated with the display of the telltale on a screen.

A naïve approach uses a guest virtual machine performs this checksum verification in a corresponding window channel. However, this type of approach is unable to detect errors in the composition and post-composition processing stages that occur right before display within the display pipeline, as a given guest virtual machine is typically allowed to control a corresponding input (e.g., window) channel that is processed using one or more preceding pre-composition processing stages within the display pipeline.

To detect telltale display errors in the composition and post-composition processing stages of the display pipeline, conventional approaches implement checksum logic in a host virtual machine with full access to the display hardware at the back of the display pipeline. However, this creates complicated communication between the guest virtual machine operating the window channel and the host virtual machine. Additionally, the host virtual machine may have trouble synchronizing with the guest virtual machine because the host virtual machine may be unable to match changes made by the guest virtual machine to a corresponding scan-out frame to be displayed on the screen. If the host virtual machine becomes out of sync with the guest virtual machine, the host virtual machine may erroneously identify a checksum mismatch when no mismatch exists and/or determine that a checksum match exists when a region of a frame associated with the checksum match fails to include a corresponding telltale.

As such, a need exists for more effective techniques for improving the detection of telltale display errors in display pipelines.

### SUMMARY

Embodiments of the present disclosure relate to end-to-end telltale verification for automotive systems and applications. The techniques described herein include receiving, from a buffer, a set of commands associated with a frame to be displayed on a screen. The techniques also include determining, based on the set of commands, (i) an expected checksum for a telltale to be included in the frame and (ii) at least a portion of the frame associated with the telltale. The techniques further include computing a checksum for the at least the portion of the frame, and causing an alert associated with the telltale to be generated based on a comparison of the computed checksum with the expected checksum.

One technical advantage of the disclosed techniques relative to prior approaches is the ability to detect errors in telltales to be displayed on a screen after multiple windows and/or input channels containing the telltales and/or other visual content have been composited into a frame. Accordingly, the disclosed techniques are able to detect telltale errors that occur in the composition and post-composition processing stages that immediately precede display of the frame on the screen. Another technical advantage of the disclosed techniques is the synchronized transmission and execution of commands for verifying the telltales with pixel values for the telltales and/or frame. Consequently, the disclosed techniques avert potential mismatch errors and/or reduce synchronization complexity over conventional approaches that involve extensive communication between a guest virtual machine operating a window channel and a host virtual machine that performs telltale verification in the composition and post-composition processing stages of the display pipeline.

### BRIEF DESCRIPTION OF THE DRAWINGS

The present systems and methods for end-to-end telltale verification for

automotive systems and applications are described in detail below with reference to the attached drawing figures, wherein:

FIG. 1 illustrates a computing device configured to implement one or more aspects of various embodiments;

FIG. 2 is a more detailed illustration of the virtual machine and display pipeline of

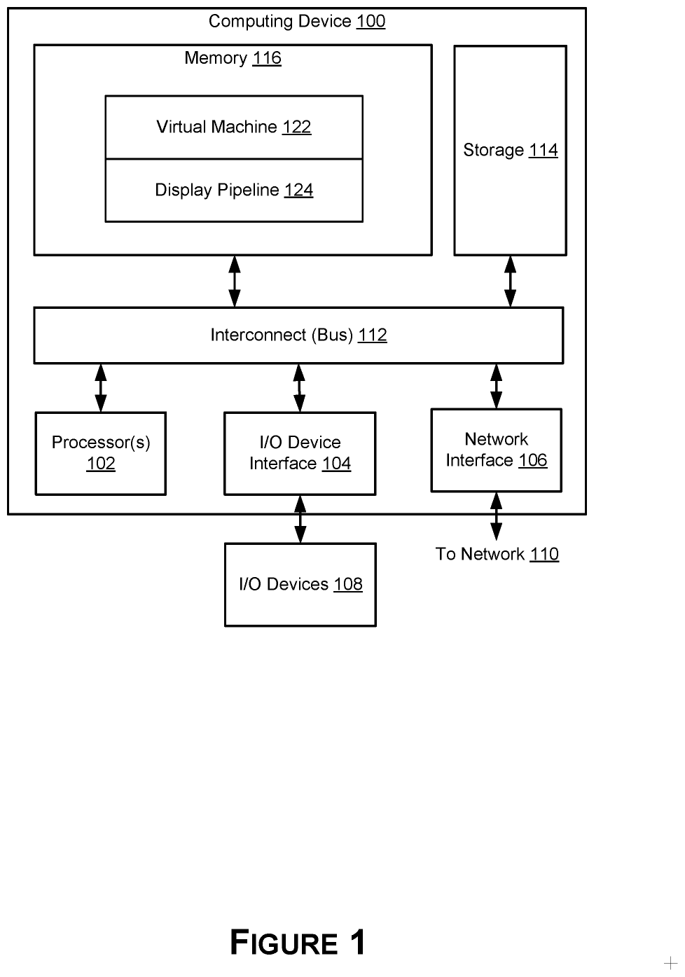

FIG. 1, according to various embodiments;

FIG. 3A illustrates an example portion of an output frame that includes a telltale, according to various embodiments;

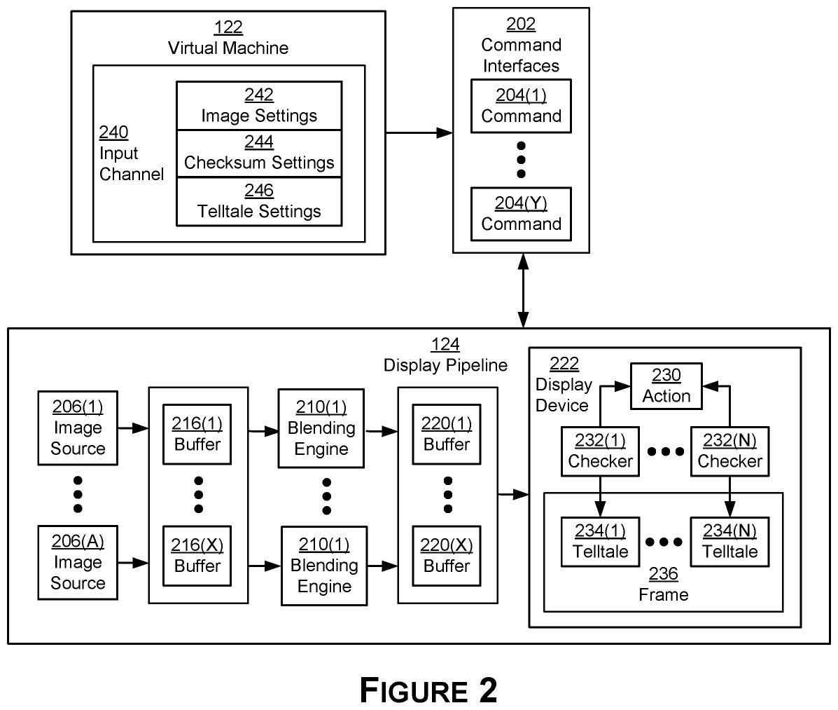

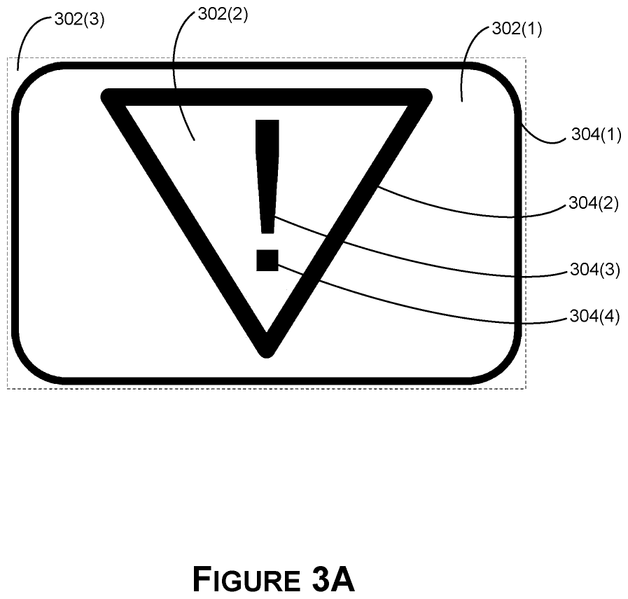

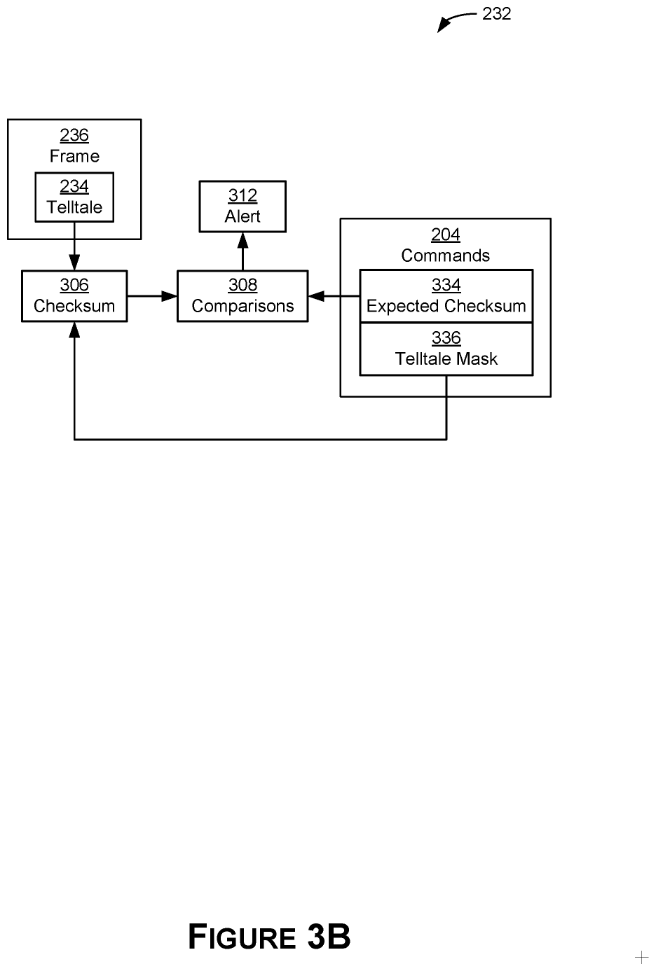

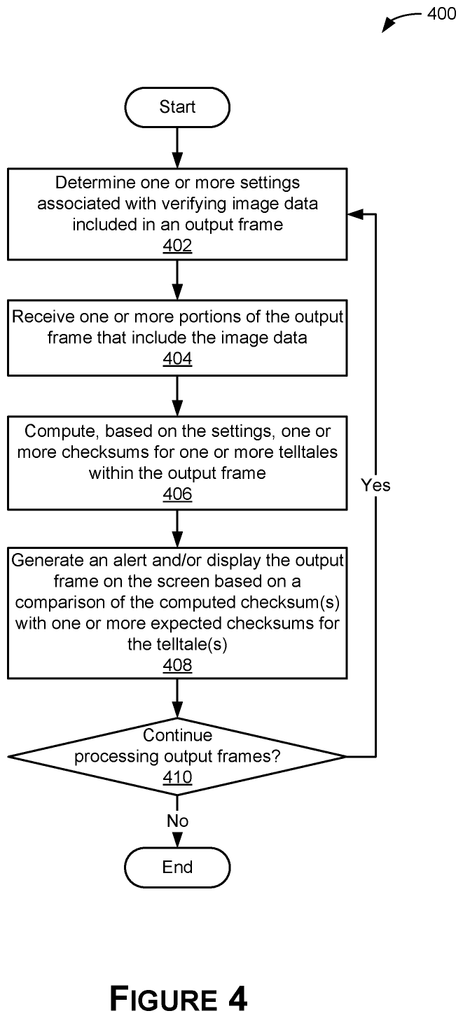

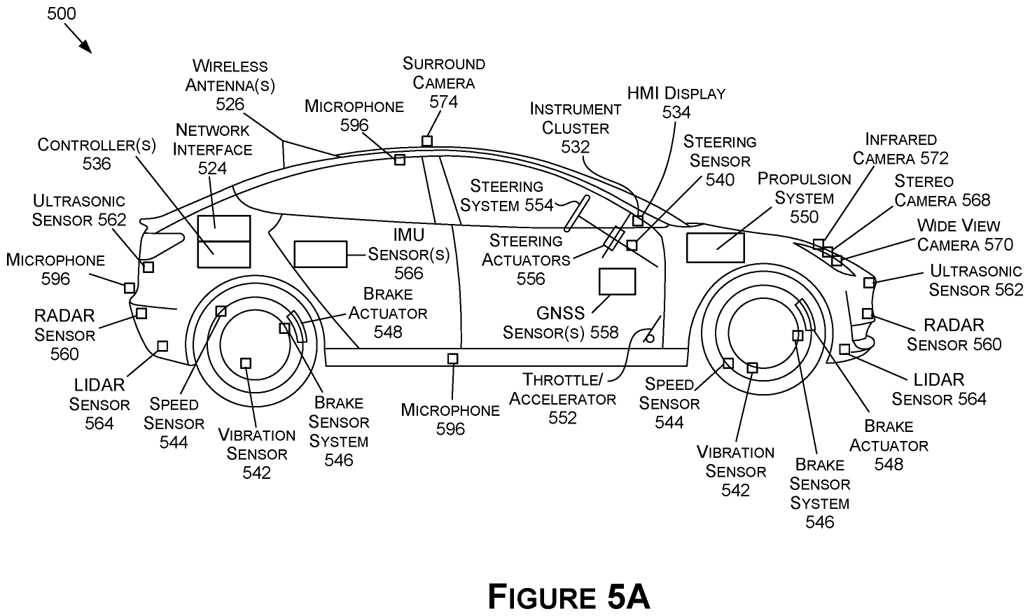

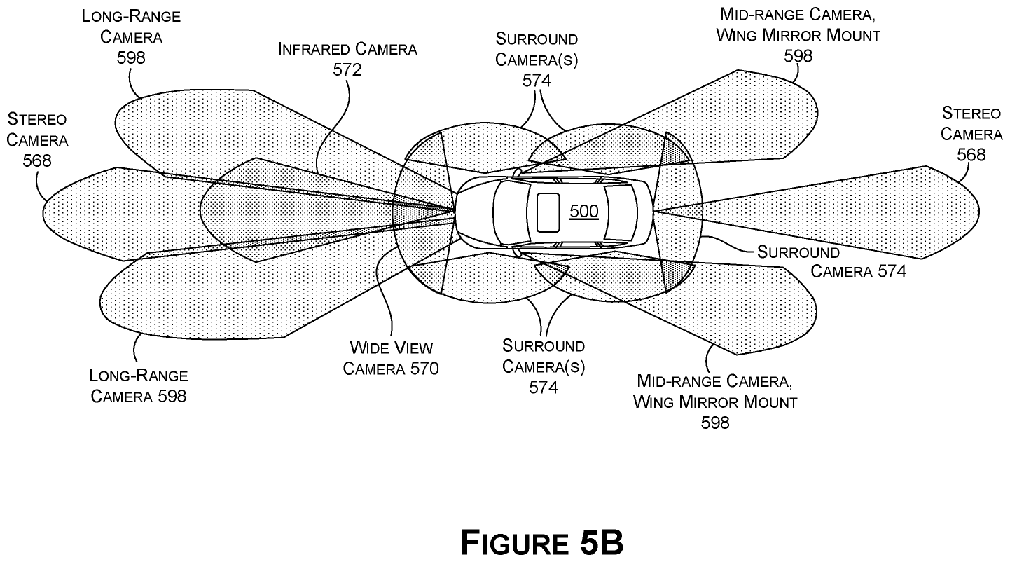

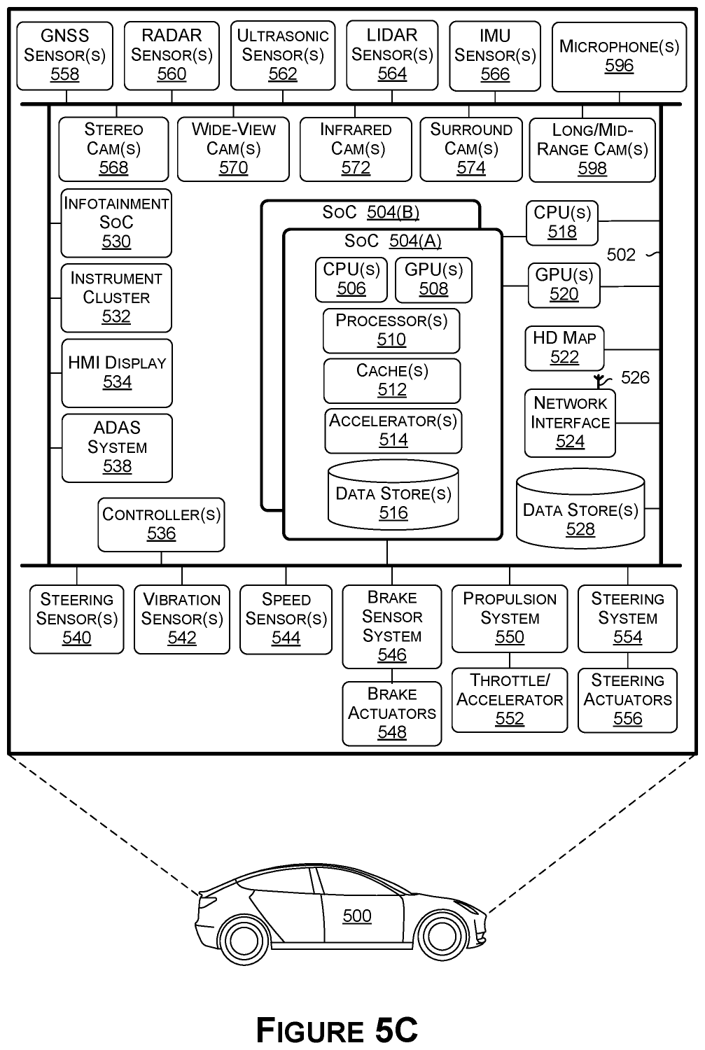

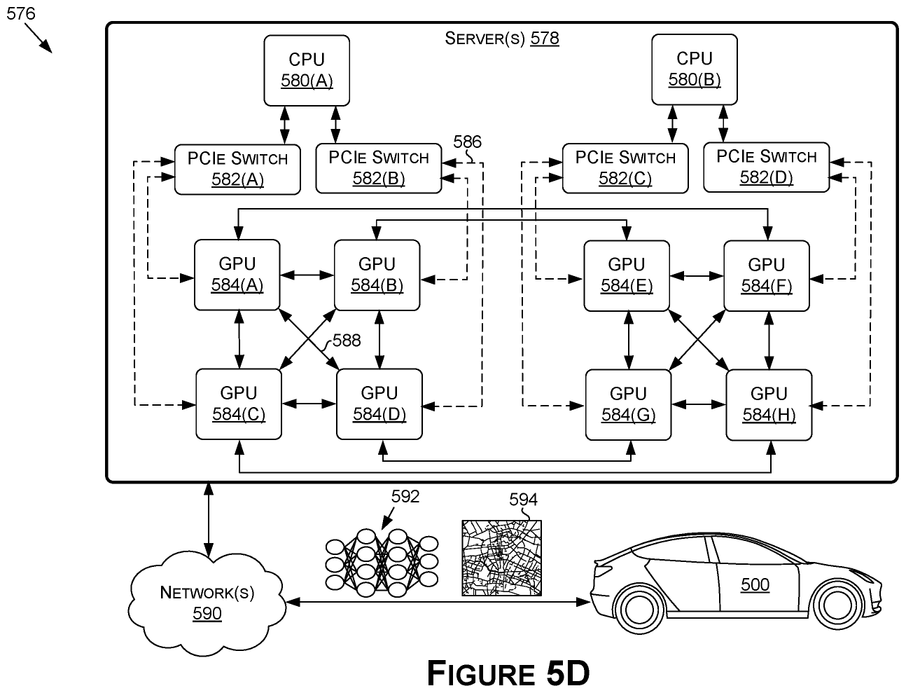

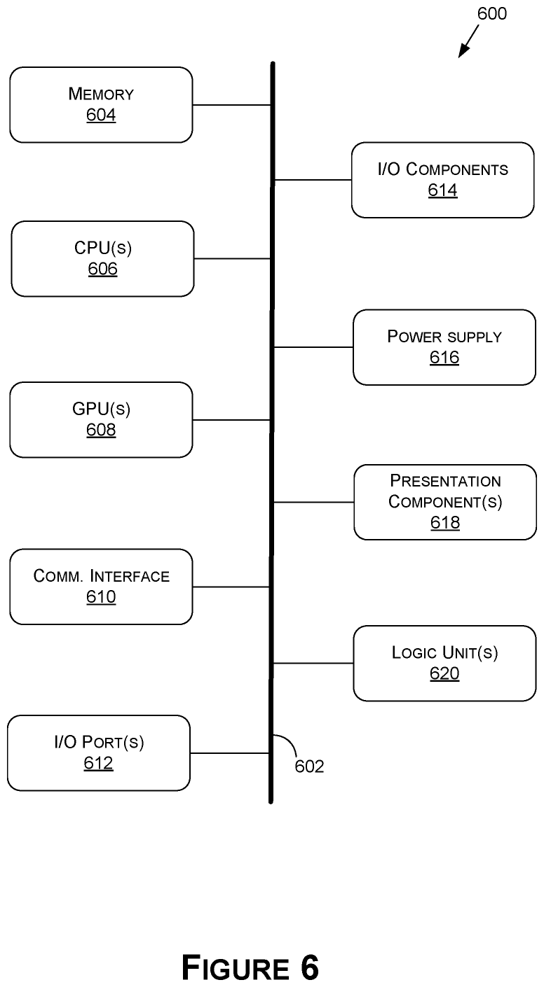

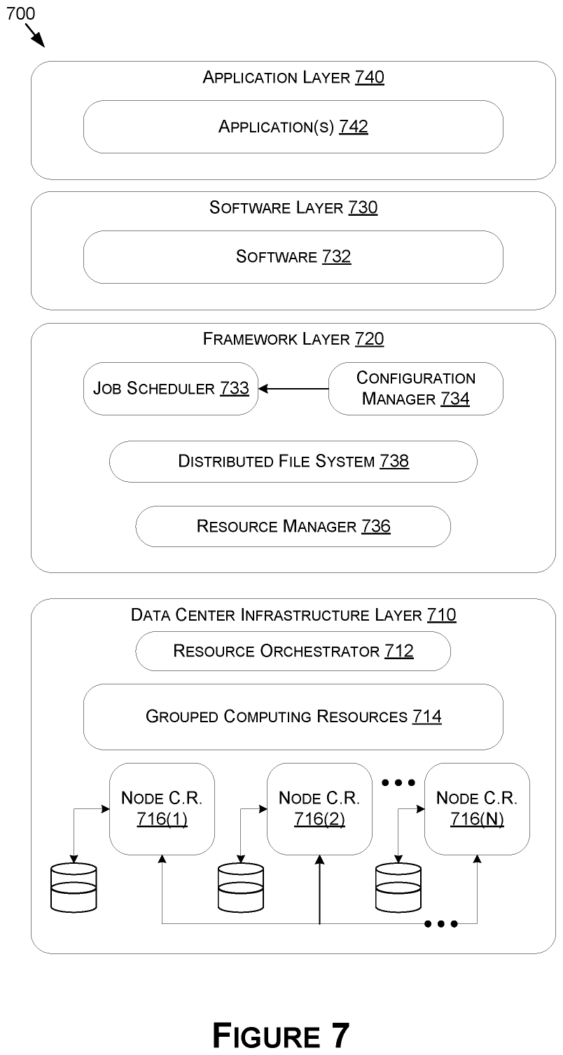

FIG. 3B is a more detailed illustration of the checker of FIG. 2, according to various embodiments;

FIG. 4 illustrates a flow diagram of a method for verifying output frames associated with one or more telltales, according to various embodiments;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to end-to-end telltale verification for automotive systems and applications. Although the present disclosure may be described with respect to an example autonomous vehicle or semi-autonomous vehicle or machine 500 (alternatively referred to herein as “vehicle 500,” “ego-vehicle 500,” “machine 500,” or “ego-machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to end-to-end telltale verification for autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where camera views may be used.

As discussed herein, a naïve approach for detecting errors associated with telltales performs a checksum verification in individual input channels during a pre-composition processing stage of a display pipeline. However, these approaches are unable to detect errors in the composition and post-composition processing stages that occur right before display within the display pipeline. At the same time, conventional approaches to detecting telltale display errors in the composition and post-composition processing stages of the display pipeline involve implementing checksum logic in a host virtual machine with full access to the display hardware at the back of the display pipeline. However, this creates complicated communication between a guest virtual machine operating the window input channel and the host virtual machine and/or issues with synchronizing the host virtual machine and the guest virtual machine, which can cause the host virtual machine to erroneously identify a checksum mismatch when no mismatch exists and/or determine that a checksum match exists when a region of a frame associated with the checksum match fails to include a corresponding telltale.

To improve the detection of telltale display errors in a display pipeline, the disclosed techniques allow a guest virtual machine operating a window channel to specify commands that can be used to verify a telltale to be displayed within a frame on a screen. The commands may include (but are not limited to) a full-screen or partial-screen surface (image) containing one or more non-overlapping telltales, settings to enable or disable the display and/or verification of individual telltales, settings for hardware checksum computation on regions containing the telltales after multiple window channels have been composed into the frame, locations of the telltales within the frame, regions of the frame corresponding to the telltales, masks that identify pixel locations of the telltales within the regions and/or frame, and/or an expected checksum value for each region. These commands are transmitted with images and/or pixel values for the corresponding windows in a flip-synchronized manner, thereby allowing a display device that drives the screen to access and execute the commands on a per-frame basis.

For example, the commands may be written to a buffer in memory that is accessible to the display device. During a period between display of a previous frame on the screen and display of a next frame on the screen, the display device may execute the commands to verify each telltale to be included in the next frame. The verification process may involve retrieving an expected checksum (e.g., cyclic redundancy check (CRC)) for each telltale from a location in memory, computing a checksum for a portion of the frame corresponding to the telltale, and comparing the computed checksum and expected checksum. If the two checksums match, no error is found, and display of the frame may proceed. If the two checksums differ, an error in the display of the telltale may be detected, and an alert and/or notification of the error may be outputted in lieu of or in addition to the frame. These commands may thus allow a given telltale to be verified for individual frames for display on the screen, including (but not limited to) the first frame that includes the telltale. Further

One technical advantage of the disclosed techniques relative to prior approaches is the ability to detect errors in telltales to be displayed on a screen after multiple windows and/or input channels containing the telltales and/or other visual content have been composited into a frame. Accordingly, the disclosed techniques are able to detect telltale errors that occur in the composition and post-composition processing stages that immediately precede display of the frame on the screen. Another technical advantage of the disclosed techniques is the synchronized transmission and execution of commands for verifying the telltales with pixel values for the telltales and/or frame. Consequently, the disclosed techniques avert potential mismatch errors and/or reduce synchronization complexity over conventional approaches that involve extensive communication between a guest virtual machine operating a window channel and a host virtual machine that performs telltale verification in the composition and post-composition processing stages of the display pipeline. This synchronized transmission and execution of commands for verifying telltales with the corresponding frames further allows telltale errors to be detected and handled as early as the first frame that includes a given telltale.

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system(s) on a chip(s), an in-vehicle computing device, and/or any other type of computing device configured to receive input, process data, and optionally display images, and is suitable for practicing one or more embodiments. Computing device 100 is configured to run a virtual machine 122 and a display pipeline 124 that may reside in a memory 116.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a parallel processing unit (PPU), a data processing unit (DPU), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center) and/or may correspond to a virtual computing instance executing within a computing cloud.

In at least one embodiment, I/O devices 108 include devices capable of receiving input, such as a keyboard, a mouse, a touch screen, a touchpad, a VR/MR/AR headset, a gesture recognition system, and/or a microphone, as well as devices capable of providing output, such as a display device(s), a haptic device(s), and/or a speaker(s). Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, a cellular network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Virtual machine 122 and/or display pipeline 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs that can be executed by processor(s) 102 and application data associated with said software programs, including virtual machine 122 and display pipeline 124.

Virtual machine 122 includes functionality to coordinate and control the processing of image data within an input channel. The input channel may correspond to an independent source (e.g., “window”) of image data that can be used to generate a frame for output on a display. This image data may include frames and/or portions of frames captured by a set of cameras. The cameras may capture multiple views of an environment around a vehicle, robotic system, surveillance system, or another type of system that includes computing device 100. This image data may also, or instead, include one or more telltales that alert users to potential hazards related to nearby objects, weather, road conditions, traffic conditions, malfunctions, failures, and/or other types of safety-related situations encountered by the system.

More specifically, virtual machine 122 is configured to execute a control flow that sets up and controls the execution of various components within a corresponding display pipeline 124 for the input channel. As described in further detail below, these components may execute multiple stages of display pipeline 124 to convert image data within the input channel into a form that can be outputted on a display and/or otherwise used by the system that includes computing device 100.

Additionally, multiple instances of virtual machine 122 and display pipeline 124 may execute on one or more instances of computing device 100, a distributed system, and/or a cloud computing system to control the processing of image data from multiple corresponding input channels into an output frame that includes one or more telltales. For example, instances of virtual machine 122 and display pipeline 124 may operate to combine multiple “windows” of image data that depict different camera views of the environment, telltales, and/or other visual content into an output frame. The output frame may then be displayed on one or more screens in a vehicle, computer system, and/or another system that includes one or more instances of computing device 100.

FIG. 2 is a more detailed illustration of virtual machine 122 and display pipeline 124 of FIG. 1, according to various embodiments. As discussed herein, virtual machine 122 configures and controls the operation of multiple components in display pipeline 124 to combine and/or convert image data from one or more image sources 206(1)-206(A) (each of which is referred to individually herein as image source 206) into a frame 236 that can be displayed on a display device 222. These components include a set of blending engines 210(1)-210(C) (each of which is referred to individually herein as blending engine 210), display device 222, a set of buffers 216(1)-216(X) (each of which is referred to individually herein as buffer 216) between image sources 206 and blending engines 210, and a set of buffers 220(1)-220(X) (each of which is referred to individually herein as buffer 220) between blending engines 210 and display device 222. Each of these components is described in further detail below.

Image sources 206 include one or more sources of image data that can be included in frame 236. For example, image sources 206 may include one or more cameras that generate a sequence of video frames at a certain rate. Video frames captured by each camera may depict an area in front of, behind, to the side of, below, and/or above a vehicle or another system in which display pipeline 124 is deployed. In another example, image sources 206 may include two-dimensional (2D) and/or three-dimensional (3D) graphics-processing components that combine multiple camera views of the environment around the system into a single image representing a two-dimensional (2D) and/or three-dimensional (3D) visualization, top-down visualization, multi-viewport visualization, and/or other view of the environment.

In some embodiments, image sources 206 include sources of one or more telltales 234(1)-234(N) (each of which is referred to individually herein as telltale 234) to be included in frame 236. As used herein, telltales 234 include alerts of safety-related conditions associated with the system in which display pipeline 124 is deployed. For example, virtual machine 122, a safety MCU, and/or another component of the system may detect a potential hazard related to a nearby object, weather, road conditions, traffic conditions, malfunctions, failures, and/or another type of safety-related condition. In response to such a potential hazard, the component may transmit a corresponding telltale 234 to display pipeline 124 for inclusion in frame 236. The component may also, or instead, transmit one or more telltales 234 for inclusion in a given frame 236 during startup of the system in which display pipeline 124 is deployed (e.g., as part of a “splash screen” that is shown during the startup process), debugging of the system and/or display pipeline 124, and/or another event that is not necessarily related to the detection of a safety-related condition.

Images, video frames, telltales, and/or other image data generated and/or provided by image sources 206 are stored in buffers 216 and subsequently read by one or more blending engines 210. Each blending engine 210 performs additional processing on the image data to generate one or more portions of frame 236 for display-by-display device 222. For example, each blending engine 210 may perform scaling, color adjustment, blending, rasterizing, and/or other operations to convert the image data into pixel values that are suitable for display-by-display device 222.

Pixel values outputted by 2D engines 210 are stored in a set of buffers 220 for subsequent consumption by display device 222. Display device 222 retrieves these pixel values from buffers 220 and performs a final composition of the data into frame 236. For example, display device 222 may compose and/or layer pixel values from multiple buffers 220, multiple instances of display pipeline 124, and/or multiple input channels corresponding to individual instances of display pipeline 124 into a single frame 236 to be displayed on a screen. After generation of frame 236 is complete, display device 222 displays this frame 236 on the screen. Display device 222 additionally updates the displayed frame 236 using new pixel values from buffers 220 according to a configurable frequency. For example, display device 222 may output frames on the screen at a frequency of around 60 Hz, while one or more cameras included in image sources 206 may capture images at a frequency of around 30 Hz. Thus, display device 222 may display a given frame 236 twice before generating a new frame 236 using new pixel values from buffers 220.

In one or more embodiments, virtual machine 122 includes applications, processes, services, user mode drivers, kernel mode drivers, and/or other components. Components within virtual machine 122 are executed in a manner that is isolated from underlying hardware and/or other virtual machines (e.g., additional instances of virtual machine 122, other types of virtual machines, etc.) on the same computing device (e.g., computing device 100 of FIG. 1). For example, virtual machine 122 and/or other virtual machines executing on the computing device may access hardware resources on the computing device via a type I hypervisor that runs directly on one or more processors in the computing device or a type II hypervisor that runs as a software layer on a host operating system executing on the computing device. The hypervisor may additionally enable or disable individual virtual machines and/or individual instances of virtual machine 122, connect one or more virtual machines and/or instances of virtual machine 122 to a given display pipeline 124 and/or display device 222, and/or otherwise configure the arrangement of virtual machines, display pipelines, and/or other components associated with displaying output frames within a given system.

As shown in FIG. 2, virtual machine 122 orchestrates the operation of various components (e.g., image sources 206, blending engines 210, display device 222, etc.) in display pipeline 124 by transmitting and/or storing commands 204(1)-204(Y) (each of which is referred to individually herein as command 204) using one or more command interfaces 202 with these components. Each of command interfaces 202 may allow virtual machine 122 to communicate with a corresponding component (or type of component) in display pipeline 124. For example, each of command interfaces 202 may include one or more command buffers, registers, and/or other locations into which virtual machine 122 writes commands 204. These commands 204 may include (but are not limited to) processing settings 242 that configure the capture of images by cameras, safety-related conditions that trigger the display of telltales 234 by safety components, processing of image data by blending engines 210, and/or composition and/or display of the image data in a given frame 236 by display device 222.

In some embodiments, the value of X denoting the number of buffers in each set of buffers 216(1)-216(X), 218(1)-218(X), and 220(1)-220(X) is set to the depth of display pipeline 124 (e.g., the number of stages in display pipeline 124). As new image data is provided by image sources 206, virtual machine 122 may write new commands 204 to command interfaces 202 in a way that causes image sources 206, blending engines 210, and/or display device 222 to cycle through the corresponding sets of buffers 216 and 220 (e.g., similar to a rolling buffer). These commands 204 may additionally cause image sources 206, blending engines 210, and/or display device 222 to capture, transmit, and/or process image data in a way that reflects the latest conditions around the system and/or the latest user input received via a user interface associated with display pipeline 124.

For example, virtual machine 122 may transmit commands 204 over command interfaces 202 to image sources 206, blending engines 210, and display device 222 in a way that is flip-synchronized with the rate at which frames are outputted on display device 222 and/or captured by cameras included in image sources 206. During this flip synchronization, virtual machine 122 may transmit commands 204 that instruct image sources 206 to switch buffers 216 to which image data is written, so that changes in images captured and/or transmitted by each image source 206 are written to different buffers 216 and the newest image data from each image source 206 is written to a given buffer 216 that previously stored the oldest image data from the same image source 206 and/or a different image source 206. Virtual machine 122 may also, or instead, transmit commands 204 that instruct each blending engine 210 to switch from reading older image data from one or more buffers 216 to reading newer image data from one or more other buffers 216 and/or write the most recent set of pixel values generated from the image data to one or more buffers 220 in which the oldest pixel values were stored. These commands 204 to blending engines 210 may additionally instruct each blending engine 210 to generate overlays and/or other pixel values to be included in frame 236 content in a way that reflects the latest environmental and/or safety-related conditions around the system. Virtual machine 122 may also, or instead, transmit commands 204 that instruct display device 222 to generate and/or display a new frame 236 by switching from reading older pixel values from one or more buffers 220 to reading newer pixel values from one or more other buffers 220.

Because display pipeline 124 includes multiple components, sets of buffers 216 and 220, and stages of processing, errors at any component and/or stage may cause display device 222 to output frame 236 content that does not include one or more telltales 234 from image sources 206, which can lead to safety issues. For example, an inability to display a given telltale 234 and/or an incorrect display of that telltale 234 may prevent the operator of a machine, vehicle, or system that includes display pipeline 124 from becoming aware of a corresponding safety-related event or condition.

In one or more embodiments, virtual machine 122 and display device 222 operate to detect and manage issues associated with the display of telltales 234 in frames to be outputted by display device 222. As shown in FIG. 2, virtual machine 122 writes commands 204 that include checksum settings 244 and telltale settings 246 to one or more command interfaces 202 associated with display device 222. One or more image sources 206 and/or safety components in display pipeline 124 may use checksum settings 244 and/or telltale settings 246 to (i) compute expected checksums for telltales 234 to be included in a given frame 236 and (ii) write the expected checksums to corresponding buffers and/or memory addresses. Display device 222 includes a number of checkers 232(1)-232(N) (each of which is referred to individually herein as checker 232) that use checksum settings 244 and/or telltale settings 246 to (i) compute checksums for regions of frame 236 that correspond to telltales 234, (ii) read expected checksums for these telltales 234 from the corresponding buffers and/or memory addresses, and (iii) compare the computed checksums to the expected checksums. These checkers 232 may be implemented using dedicated circuits, microcontrollers, and/or other hardware components on display device 222.

As used herein, a checksum refers to a data element that is derived from another block of data for the purpose of detecting errors or changes to the block of data during storage or transmission. A checksum may be computed using CRCs, hash functions, parity checks, Fletcher checksums, Adler checksums, and/or other techniques for converting a block of data into values that can be used to “check” or verify the integrity of the block of data.

In some embodiments, checksum settings 244 are used to configure the verification of checksums for telltales 234 to be included in a given frame 236. For example, checksum settings 244 may include (but are not limited to) a type of checksum to compute for each telltale 234 in a given frame 236, the number of checksums to compute for a given telltale 234 and/or frame 236, the location (e.g., address, buffer, etc.) of an expected checksum for each telltale 234, rules for generating alerts based on comparisons of computed checksums with the expected checksums for the same telltales 234, and/or other settings related to using checksums to verify telltales 234.

Telltale settings 246 define telltales 234 within a given frame 236 for which checksums are to be verified. For example, telltale settings 246 may include (but are not limited to) images, shapes, pixel values, boundaries, and/or other representations of each telltale 234; one or more types of telltales 234 (e.g., telltales 234 corresponding to safety alerts, proximity alerts, weather alerts, road condition alerts, etc.) to be included in frame 236; flags to enable and/or disable a given checker 232 and/or corresponding telltale 234; locations (e.g., memory addresses and/or buffers 220) in which image data for a given telltale 234 is stored; a total number of telltales 234 for which checksums are to be verified; and/or other settings related to defining telltales 234 to be displayed and/or verified within frame 236 content. As content in each frame 236 is updated to reflect the latest environment and/or conditions around the system, telltale settings 246 may also be updated to specify telltales 234 within each frame 236 that correspond to indications of safety hazards associated with the environment and/or conditions.

In one or more embodiments, a given telltale 234 includes one or more arbitrarily shaped regions within a given frame 236. These regions may be included in a larger rectangular region (or a larger arbitrarily shaped region) from which a checksum for that telltale 234 is computed. One or more portions of this larger region that are not a part of that telltale 234 may additionally include pixel values that vary with image data that is composited and/or layered with telltale 234 to form frame 236, as discussed in further detail below with respect to FIG. 3A.

FIG. 3A illustrates an example portion of an output frame (e.g., frame 236 of FIG. 2) that includes a telltale (e.g., telltales 234 of FIG. 2), according to various embodiments. As shown in FIG. 3A, the portion includes a rectangular region within the output frame. This region includes a number of sub-regions 304(1)-304(4) that form a telltale to be displayed within the rectangular region. More specifically, sub-region 304(1) includes a rounded rectangle that represents an outer boundary of the telltale, sub-regions 304(2) includes an upside-down rectangle that is disposed within the rounded rectangle, and sub-regions 304(3)-304(4) form an exclamation mark that is disposed within the upside-down rectangle. Pixels within sub-regions 304(1)-304(4) may be opaque to ensure that the telltale is visible to a user to which the output frame is displayed.

The portion also includes a number of sub-regions 302(1)-302(3) that are not included in the telltale. Sub-region 302(1) corresponds to an area between the rounded rectangle of sub-region 304(1) and the upside-down triangle of sub-region 304(2), sub-region 302(2) corresponds to an area between the upside-down triangle of sub-region 304(2) and the exclamation mark formed by sub-regions 304(3)-304(4), and sub-region 302(3) corresponds to an area outside the rounded rectangle of sub-region 304(1). Unlike sub-regions 304(1)-304(4) corresponding to the telltale, pixels in sub-regions 302(1)-302(3) may be partially and/or fully transparent to allow the telltale to be overlaid on top of other image data. For example, sub-regions 302(1)-302(2) may include partially transparent pixels to allow the telltale to blend with image data (e.g., a camera view and/or visualization) from an underlying window and/or input channel. Sub-region 302(3) may include fully transparent pixels to allow image data that is outside of the telltale to be shown on screen.

In one or more embodiments, sub-regions 304(1)-304(4) corresponding to the telltale and sub-regions 302(1)-302(3) that are not included in the telltale are denoted using an alpha channel of RGBA pixel values for the rectangular region of FIG. 3A. For example, the alpha channel may define a mask that denotes pixel locations corresponding to the telltale within the larger rectangular region. Within the alpha channel, a value of 1 may be stored in pixel locations corresponding to sub-regions 304(1)-304(4) to indicate that the corresponding pixel values are to be used in computing a checksum for the telltale. The alpha channel may store a value that ranges from 0 to less than 1 in pixel locations within sub-regions 302(1)-302(3) to indicate that the corresponding pixel values are to be excluded from the checksum for the telltale. An alpha channel value of 0 may indicate that the corresponding pixel location is fully transparent (e.g., to allow image data from a different window and/or input channel to be fully visible at that pixel location). An alpha channel value that is between 0 and 1 may indicate that the corresponding pixel location is partially transparent (e.g., to allow image data from a different window and/or input channel to be blended with a pixel value for the telltale at that pixel location), with a lower alpha channel value indicating a higher degree of transparency.

Returning to the discussion of FIG. 2, each checker 232 in display device 222 verifies a corresponding telltale 234 within a given frame 236 to be shown on screen by display device 222 by retrieving one or more commands 204 from one or more command interfaces 202 with virtual machine 122. Each checker 232 uses telltale settings 246 specified in the retrieved commands 204 to obtain pixel values representing that telltale 234. Each checker 232 also uses checksum settings 244 specified in the retrieved commands 204 to compute a checksum for the pixel values corresponding to the telltale 234 and compare the computed checksum with an expected checksum for the telltale 234. Each checker 232 further generates alerts and/or other output based on the results of the comparison. The operation of checkers 232 is described in further detail below with respect to FIG. 3B.

FIG. 3B is a more detailed illustration of checker 232 of FIG. 2, according to various embodiments. As shown in FIG. 3B, checker 232 computes a checksum 306 for a given telltale 234 within an output frame 236 to be displayed on display device 222. For example, checker 232 may receive one or more telltale settings 246 and/or checksum settings 244 in the form of one or more commands 204 from virtual machine 122. Checker 232 may use these settings to determine a telltale mask 336 that identifies pixel locations corresponding to telltale 234 within frame 236 (or a region with frame 236) and/or retrieve pixel values corresponding to the telltale from frame 236. Checker 232 may also use these settings to compute a CRC and/or another type of checksum 306 using pixel values at the identified pixel locations.

As discussed herein, telltale mask 336 may be defined in an alpha channel for frame 236 and/or a region within frame 236 that includes telltale 234. For example, the alpha channel may store a certain pixel value (e.g., 1) at pixel locations corresponding to telltale 234 and a different pixel value (e.g., not 1) at pixel locations that do not correspond to telltale 234. If telltale mask 336 is defined for telltale 234, checker 232 may compute checksum 306 using pixel values at these pixel locations. If telltale mask 336 is not defined for telltale 234, checker 232 may compute checksum 306 using pixel values that fall within the boundaries of a rectangular region (or another portion of frame 236) that is specified in commands 204 as corresponding to telltale 234.

Checker 232 performs comparisons 308 of checksum 306 with an expected checksum 334 for the same telltale 234. For example, checker 232 may read expected checksum 334 from a location (e.g., memory address, buffer, etc.) specified in one or more commands 204 from virtual machine 122 and determine whether or not the computed checksum 306 matches expected checksum 334. This expected checksum 334 may be computed from image data for telltale 234 by a source of the image data and/or another component operating on an input channel that includes the image data. This expected checksum 334 may also, or instead, be extracted from a given checker 232 (e.g., after the checker has computed the checksum from image data for a given telltale 234 that is provided and/or verified by a developer).

Checker 232 also generates an alert 312 based on the results of comparisons 308. More specifically, checker 232 outputs alert 312 when the computed checksum 306 does not match expected checksum 334 (e.g., to indicate a potential error associated with the display of telltale 234 on a screen). Conversely, checker 232 may omit alert 312 when the computed checksum 306 matches expected checksum 334 (e.g., because no error is detected in the portion of frame 236 corresponding to telltale 234).

Returning to the discussion of FIG. 2, a display controller in display device 222 combines the results of checksum comparisons performed by all checkers 232 for a given frame 236 into an action 230 that is performed with respect to that frame 236. For example, the display controller may drop frame 236 and/or one or more subsequent frames, blank the screen, output an error related to display of the telltale (e.g., as an overlay, audio output, tactile output, etc.), and/or perform another action 230 to prevent a user from operating a system that includes display device 222 and/or making decisions using stale, misleading, or less safe than desirable image data in response to receiving one or more alerts of checksum mismatches from checkers 232. Conversely, the display controller may display a given frame 236 and/or one or more subsequent frames upon determining that no checksum mismatches were detected by checkers 232 for telltales 2343 to be included in that frame 236.

In another example, the display controller may determine an overall “error level” associated with a given frame 236 as a sum and/or other aggregation of priority and/or importance levels associated with all telltales 234 for which checksum mismatches were detected by the corresponding checkers 232. If the overall error level does not meet a threshold, the display controller may display frame 236 with or without an additional notification of a potential error related to display of telltales 234 in frame 236. If the overall error level exceeds the threshold, the display controller may drop frame 236, blank the screen, and/or perform another action 230 to prevent a user from operating a system that includes display device 222 and/or making decisions using stale, misleading, or less safe than desirable image data.

In a third example, the display controller may use a counter to track the number of consecutive frames in which telltale 234 errors were detected. When errors in one or more telltales 234 are detected within a given frame 236, the display controller may increment the counter. When errors in telltales 234 are not found in a given frame 236 and/or a certain number of consecutive frames, the display controller may reset the counter. If the counter does not meet or exceed a threshold, the display controller may display frame 236 on the screen. If the counter meets or exceeds the threshold, the display controller may drop frame 236; blank the screen; output a visual, audio, tactile, and/or another type of notification of potential errors in telltales 234 on the screen; and/or perform another action 230 to mitigate potential safety issues associated with the accumulation of potential telltale 234 errors across frames displayed on the screen.

In a fourth example, the display controller may use time series analysis and/or machine learning techniques to determine action 230 based on alerts and/or other data from checkers 232. These techniques may indicate that a given frame 236 is to be outputted on a screen when a sequence of alerts and/or other data from checkers 232 for the N most recent frames is associated with less than a threshold likelihood of a certain type of safety issue and/or another outcome. These techniques may also, or instead, indicate that frame 236 is to be dropped, the screen is to be blanked, an alert indicating that the screen may include telltale 234 errors is to be outputted, and/or another action 230 related to the management of potentially erroneous telltale 234 content in frame 236 is to be performed when the sequence is associated with at least the threshold likelihood of the outcome.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 5A-5D, example computing device 600 of FIG. 6, and/or example data center 700 of FIG. 7.

Now referring to FIG. 4, each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the system of FIGS. 1-3. However, these methods may additionally or alternatively be executed by any one system, or any combination of systems, including, but not limited to, those described herein.

FIG. 4 illustrates a flow diagram of a method for verifying output frames associated with one or more telltales, according to various embodiments. As shown in FIG. 4, method 400 begins with operation 402, in which display device 222 determines one or more settings associated with verifying image data included in an output frame 236. For example, display device 222 may receive the settings in the form of one or more commands from virtual machine 122. These commands may be received via one or more command interfaces, command buffers, registers, and/or other sources. The settings may define rectangular regions and/or other portions of the output frame 236 that include telltales 234 to be verified, a type of checksum to compute for each portion of the output frame 236, the number of checksums to compute for the output frame 236, locations of expected checksums for telltales 234, rules for generating alerts based on comparisons of the computed checksums with the expected checksums, and/or other settings related to using checksums to detect and/or manage errors in the display of telltales 234 within output frames by display device 222.

In operation 404, display device 222 receives one or more portions of the output frame 236 that include the image data. For example, display device 222 may read the image data from one or more buffers 220 included in one or more instances of display pipeline 124. Each buffer 220 read by display device 222 and/or each input channel represented by a corresponding instance of display pipeline 124 may store at least a subset of pixel values to be included in the output frame 236.

In operation 406, display device 222 computes, based on the settings, one or more checksum for one or more telltales 234 within the output frame 236. Continuing with the above example, display device 222 may composite, layer, and/or otherwise combine the image data from multiple buffers and/or input channels into the output frame 236. Display device 222 may then use a telltale mask and/or other information in the settings to identify one or more portions of the output frame 236 that correspond to a given telltale and compute a checksum from pixel values in those portion(s).

In operation 408, display device 222 generates an alert and/or displays the output frame 236 on the screen based on a comparison of the computed checksum(s) with one or more expected checksums for the telltale(s). For example, display device 222 may include a separate checker 232 for each telltale 234. Each checker 232 may retrieve an expected checksum for the corresponding telltale 234 from a memory address and/or another location specified in the settings and compare the expected checksum to the computed checksum for that telltale 234. If a given checker 232 determines that the computed checksum for the corresponding telltale 234 does not match the expected checksum for that telltale 234, that checker 232 may output an alert of the mismatch. If a given checker 232 determines that the computed checksum for the corresponding telltale 234 matches the expected checksum for that telltale 234, that checker 232 may omit generation of an alert for that telltale 234 and/or generate a different alert indicating that no checksum mismatch was detected. Display device 222 may then compare the number of alerts received from checkers 232 and/or the number of consecutive frames for which alerts were received from checkers 232 with a threshold. If the threshold is met or exceeded, a display controller in display device 222 may generate an error that is outputted on the screen in lieu of or in addition to the output frame 236 (e.g., as an overlay, audio output, tactile output, etc.), used to drop the output frame 236, used to blank the screen, and/or used to perform another action 230 to prevent the user from operating a system that includes display device 222 and/or making decisions using stale, misleading, or less safe than desirable image data. If the threshold is not met or exceeded, display device 222 may cause the output frame 236 to be outputted on the screen.

In operation 410, display device 222 determines whether or not to continue processing output frames. For example, display device 222 may continue to process output frames while the output frames are generated for display on the screen and/or used to display telltales 234. While display device 222 continues processing output frames, display device 222 repeats operations 402, 404, 406, and 408 for each output frame 236. Display device 222 may continue processing output frames in this manner until output frames that include telltales, image data, and/or input channels are no longer outputted on the display device.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more large language models (LLMs), one or more vision language models (VLMs), one or more multi modal language models, etc., systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.). In another example, the HMI display 534 may display one or more telltales that are verified using the techniques discussed herein.

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may include radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information. In some embodiments, the infotainment SoC 530 may be used to display telltales that indicate various safety-related conditions around the vehicle. These telltales may be verified using the techniques discussed herein.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU- powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, the outputted data includes visual telltales that alert a driver to potential safety-related conditions around a vehicle or system in which computing device 600 resides. Individual telltales within frames to be outputted by the presentation component(s) 618 may be verified prior by comparing checksums for portions of the frame that correspond to the telltales with expected checksums for the telltales, as discussed herein.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment-and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, the disclosed techniques allow a guest virtual machine operating a window channel to specify commands that can be used to verify a telltale to be displayed within a frame on a screen. The commands may include (but are not limited to) a full-screen or partial-screen surface (image) containing one or more non-overlapping telltales, settings to enable or disable the display and/or verification of individual telltales, settings for hardware checksum computation on regions containing the telltales after multiple window channels have been composed into the frame, locations of the telltales within the frame, regions of the frame corresponding to the telltales, masks that identify pixel locations of the telltales within the regions and/or frame, and/or an expected checksum value for each region. These commands are transmitted with images and/or pixel values for the corresponding windows in a flip-synchronized manner, thereby allowing a display device that drives the screen to access and execute the commands on a per-frame basis.

For example, the commands may be written to a buffer in memory that is accessible to the display device. During a period between display of a previous frame on the screen and display of a next frame on the screen, the display device may execute the commands to verify each telltale to be included in the next frame. The verification process may involve retrieving an expected checksum (e.g., cyclic redundancy check (CRC)) for each telltale from a location in memory, computing a checksum for a portion of the frame corresponding to the telltale, and comparing the computed checksum and expected checksum. If the two checksums match, no error is found, and display of the frame may proceed. If the two checksums differ, an error in the display of the telltale may be detected, and an alert and/or notification of the error may be outputted in lieu of or in addition to the frame.
1. In some embodiments, a method comprises receiving, from one or more buffers, a set of commands associated with a frame to be displayed on a screen; determining, based at least on the set of commands, (i) an expected checksum for a telltale to be included in the frame and (ii) at least a portion of the frame associated with the telltale; computing a checksum for the at least the portion of the frame; and causing an alert associated with the telltale to be generated based at least on a comparison of the computed checksum with the expected checksum.
2. The method of clause 1, further comprises computing a second checksum for at least a second portion of the frame corresponding to a second telltale; and causing a second alert associated with the second telltale to be generated based at least on another comparison of the computed second checksum and a second expected checksum for the second telltale.
3. The method of any of clauses 1-2, further comprises preventing display of the frame or another frame on the screen based at least on the alert and the second alert.
4. The method of clause any of clauses 1-3, wherein the at least the portion of the frame comprises a region within the frame.
5. The method of claim any of clauses 1-4, wherein the computing the checksum comprises determining a mask associated with the at least the portion of the frame; and computing the checksum based at least on a set of pixel values that correspond to the mask within the frame.
6. The method of any of clauses 1-5, wherein the mask is specified using a set of alpha channel values associated with the at least the portion of the frame.
7. The method of any of clauses 1-6, wherein the causing the alert to be generated comprises causing an error to be outputted upon determining that the computed checksum does not match the expected checksum.
8. The method of any of clauses 1-7, wherein the causing the alert to be generated comprises incrementing a counter upon determining that the computed checksum does not match the expected checksum; and causing an error to be outputted upon determining that the counter meets or exceeds a threshold.
9. The method of any of clauses 1-8, further comprising performing the comparison of the computed checksum with the expected checksum after the frame is generated using a composition of image data from a plurality of input channels.
10. The method of any of clauses 1-9, wherein the telltale comprises at least one of a safety alert, a proximity alert, a weather alert, or a road condition alert.

110. In some embodiments, a processor comprises one or more circuits to perform operations comprises receiving, from a buffer, a set of commands associated with a frame to be displayed on a screen; determining, based at least on the set of commands, (i) an expected checksum for a telltale to be included in the frame and (ii) at least a portion of the frame associated with the telltale; computing a checksum for the at least the portion of the frame; and causing an alert associated with the telltale to be generated based at least on a comparison of the computed checksum with the expected checksum.
12. The processor of clause 11, wherein the operations further comprise computing a second checksum for at least a second portion of the frame corresponding to a second telltale; and causing a second alert associated with the second telltale to be generated based at least on another comparison of the computed second checksum and a second expected checksum for the second telltale.
13. The processor of any of clauses 11-12, wherein the operations further comprise receiving, from the buffer, a second set of commands associated with a second frame to be displayed on the screen; computing one or more additional checksums for one or more portions of the second frame that correspond to one or more additional telltales; and causing the second frame to be displayed on the screen based at least on one or more additional comparisons of the one or more additional checksums and one or more additional expected checksums for the one or more additional telltales.
14. The processor of any of clauses 11-13, wherein the determining the expected checksum comprises retrieving the expected checksum from a location specified in the set of commands, wherein the expected checksum was written to the location by a component based at least on a second set of commands associated with the frame.
15. The processor of any of clauses 11-14, wherein the computing the checksum comprises determining, based at least on the set of commands, (i) a region within the frame that corresponds to the at least the portion and (ii) a mask corresponding to the telltale within the region; and computing the checksum based at least on a set of pixel values that correspond to the mask within the region.
16. The processor of any of clauses 11-15, wherein the processor corresponds to a display controller for the screen and the screen is included in a vehicle.
17. The processor of any of clauses 11-16, wherein the set of commands was written to the buffer by a virtual machine that controls a display pipeline that includes the display controller based on an inclusion of the telltale in one or more input channels to be composed into the frame.
18. The processor of any of clauses 11-17, wherein the processor is comprised in at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implementing one or more large language models (LLMs); a system implementing one or more vision language models (VLMs); a system implementing one or more multi modal language models; a system for performing one or more generative AI operations; a system implementing one or more large language models (LLMs); a system for generating synthetic data; a system incorporating one or more virtual machines (VMs); a system implemented at least partially in a data center; or a system implemented at least partially using cloud computing resources.
18. In some embodiments, a system comprises one or more processing units; and one or more memory units storing instructions that, when executed by the one or more processing units, cause the one or more processing units to execute operations comprising receiving, from a buffer, a set of commands associated with a frame to be displayed on a screen; determining, based at least on the set of commands, (i) an expected checksum for a telltale to be included in the frame and (ii) at least a portion of the frame associated with the telltale; computing a checksum for the at least the portion of the frame; and determining whether to generate an alert associated with the telltale to be generated based at least on a comparison of the computed checksum with the expected checksum.
20. The system of clause 19, wherein the system is comprised in at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system for generating or presenting at least one of virtual reality content, augmented reality content, or mixed reality content; a system implemented using a robot; a system for performing one or more conversational AI operations; a system implementing one or more large language models (LLMs); a system implementing one or more vision language models (VLMs); a system implementing one or more multi modal language models; a system for performing one or more generative AI operations; a system implementing one or more large language models (LLMs); a system for generating synthetic data; a system incorporating one or more virtual machines (VMs); a system implemented at least partially in a data center; or

One technical advantage of the disclosed techniques relative to prior approaches is the ability to detect errors in telltales to be displayed on a screen after multiple windows and/or input channels containing the telltales and/or other visual content have been composited into a frame. Accordingly, the disclosed techniques are able to detect telltale errors that occur in the composition and post-composition processing stages that immediately precede display of the frame on the screen. Another technical advantage of the disclosed techniques is the synchronized transmission and execution of commands for verifying the telltales with pixel values for the telltales and/or frame. Consequently, the disclosed techniques avert potential mismatch errors and/or reduce synchronization complexity over conventional approaches that involve extensive communication between a guest virtual machine operating a window channel and a host virtual machine that performs telltale verification in the composition and post-composition processing stages of the display pipeline.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving, from one or more buffers, a set of commands associated with a frame to be displayed on a screen;
determining, based at least on the set of commands, (i) an expected checksum for a telltale to be included in the frame and (ii) at least a portion of the frame associated with the telltale;
computing a checksum for the at least the portion of the frame; and
causing an alert associated with the telltale to be generated based at least on a comparison of the computed checksum with the expected checksum.

2. The method of claim 1, further comprising:
computing a second checksum for at least a second portion of the frame corresponding to a second telltale; and
causing a second alert associated with the second telltale to be generated based at least on another comparison of the computed second checksum and a second expected checksum for the second telltale.

3. The method of claim 2, further comprising preventing display of the frame or another frame on the screen based at least on the alert and the second alert.

4. The method of claim 1, wherein the at least the portion of the frame comprises a region within the frame.

5. The method of claim 1, wherein the computing the checksum comprises:
determining a mask associated with the at least the portion of the frame; and
computing the checksum based at least on a set of pixel values that correspond to the mask within the frame.

6. The method of claim 5, wherein the mask is specified using a set of alpha channel values associated with the at least the portion of the frame.

7. The method of claim 1, wherein the causing the alert to be generated comprises causing an error to be outputted upon determining that the computed checksum does not match the expected checksum.

8. The method of claim 1, wherein the causing the alert to be generated comprises:
incrementing a counter upon determining that the computed checksum does not match the expected checksum; and
causing an error to be outputted upon determining that the counter meets or exceeds a threshold.

9. The method of claim 1, further comprising performing the comparison of the computed checksum with the expected checksum after the frame is generated using a composition of image data from a plurality of input channels.

10. The method of claim 1, wherein the telltale comprises at least one of a safety alert, a proximity alert, a weather alert, or a road condition alert.

11. A processor comprising:
one or more circuits to perform operations comprising:
receiving, from a buffer, a set of commands associated with a frame to be displayed on a screen;
determining, based at least on the set of commands, (i) an expected checksum for a telltale to be included in the frame and (ii) at least a portion of the frame associated with the telltale;
computing a checksum for the at least the portion of the frame; and
causing an alert associated with the telltale to be generated based at least on a comparison of the computed checksum with the expected checksum.

12. The processor of claim 11, wherein the operations further comprise:
computing a second checksum for at least a second portion of the frame corresponding to a second telltale; and
causing a second alert associated with the second telltale to be generated based at least on another comparison of the computed second checksum and a second expected checksum for the second telltale.

13. The processor of claim 11, wherein the operations further comprise:
receiving, from the buffer, a second set of commands associated with a second frame to be displayed on the screen;
computing one or more additional checksums for one or more portions of the second frame that correspond to one or more additional telltales; and
causing the second frame to be displayed on the screen based at least on one or more additional comparisons of the one or more additional checksums and one or more additional expected checksums for the one or more additional telltales.

14. The processor of claim 11, wherein the determining the expected checksum comprises retrieving the expected checksum from a location specified in the set of commands, wherein the expected checksum was written to the location by a component based at least on a second set of commands associated with the frame.

15. The processor of claim 11, wherein the computing the checksum comprises:
determining, based at least on the set of commands, (i) a region within the frame that corresponds to the at least the portion and (ii) a mask corresponding to the telltale within the region; and
computing the checksum based at least on a set of pixel values that correspond to the mask within the region.

16. The processor of claim 11, wherein the processor corresponds to a display controller for the screen and the screen is included in a vehicle.

17. The processor of claim 16, wherein the set of commands was written to the buffer by a virtual machine that controls a display pipeline that includes the display controller based on an inclusion of the telltale in one or more input channels to be composed into the frame.

18. The processor of claim 11, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implementing one or more large language models (LLMs);
a system implementing one or more vision language models (VLMs);
a system implementing one or more multi modal language models;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A system comprising:
one or more processing units; and
one or more memory units storing instructions that, when executed by the one or more processing units, cause the one or more processing units to execute operations comprising:
receiving, from a buffer, a set of commands associated with a frame to be displayed on a screen;
determining, based at least on the set of commands, (i) an expected checksum for a telltale to be included in the frame and (ii) at least a portion of the frame associated with the telltale;
computing a checksum for the at least the portion of the frame; and
determining whether to generate an alert associated with the telltale to be generated based at least on a comparison of the computed checksum with the expected checksum.

20. The system of claim 19, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implementing one or more large language models (LLMs);
a system implementing one or more vision language models (VLMs);
a system implementing one or more multi modal language models;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
